(19) United States
(12) Patent Application Publication
(10) Pub. No.: US 2017/0160079 A1
(43) Pub. Date: Jun. 8, 2017

(54) METHOD FOR CORRECTING SURFACE SHAPE DATA OF ANNULAR ROTATING BODY AND APPARATUS FOR INSPECTING APPEARANCE OF ANNULAR ROTATING BODY

(71) Applicant: BRIDGESTONE CORPORATION, Tokyo (JP)

(72) Inventor: Taro TAKEBUCHI, Tokyo (JP)

(73) Assignee: BRIDGESTONE CORPORATION, Tokyo (JP)

(21) Appl. No.: 15/320,531

(22) PCT Filed: Jun. 15, 2015
(86) PCT No.: PCT/JP2015/067191

§ 371 Date: Dec. 20, 2016

(30) Foreign Application Priority Data
Jun. 20, 2014 (JP) 2014-126888

(51) Int. Cl. G01B 11/25; G01M 17/02

(52) U.S. Cl. CPC G01B 11/2522; G01B 11/2545; G01M 17/027; G01M 17/021

(57) ABSTRACT

A method for correcting annular rotating body's surface shape data in correcting three-dimensional shape data on annular rotating body's surface, a reference line is set along the surface to detect the annular rotating body, and then reference equiangular division points are set. The circumferential length of reference line is calculated from distance between adjacent reference equiangular division points, and a plurality of reference equidistant division points, which divide reference line into equal lengths, are set on reference line. Then interpolation points for correction of data on surface to be detected of annular rotating body are set at positions a preset distance apart in radial direction of rotating body from the reference equidistant division points. Three-dimensional shape data at interpolation points are calculated using the three-dimensional data to be corrected. Finally interpolation points are moved onto a circle centered about rotational center and having same circumferential length as aforementioned circumferential length.

### TECHNICAL FIELD

The present invention relates to a method for correcting surface shape data of an annular rotating body, such as a tire, to be used in inspecting the appearance thereof and an apparatus for inspecting the appearance thereof.

### BACKGROUND ART

Known as one of tire inspections is an appearance inspection for determining acceptance or rejection of the tire. In this inspection, the tire surface shape is detected using a light-section method, and the presence or absence of shape defects, such as undesirable bumps, dents, and marks, on the tire surface is checked.

In the light-section method, the images of the portion illuminated by slit light of the surface of an object to be inspected while the object is being moved are captured, and the three-dimensional shape data of the surface of the object to be inspected are measured from the pixel data of the captured images. And when the object to be inspected is an annular rotating body, such as a tire, the surface shape of the whole circumference of the object is detected as the object is turned one revolution about the central axis thereof (see Patent Document 2, for instance).

### CONVENTIONAL ART DOCUMENT

### Patent Document

Patent Document 1: Japanese Unexamined Patent Application Publication No. 2008-221896

### SUMMARY OF THE INVENTION

### Problem to be Solved by the Invention

There are cases, however, where the object to be inspected is rotated eccentrically and thus there is no agreement between the central axis and the rotational axis of the object to be inspected. In such cases, the three-dimensional shape data of the surface of the object obtained by a conventional method are distorted from the actual shape. The distortion of the object due to eccentricity can be corrected by using certain correction methods, such as the least square method (least square center method) of a circle on the assumption that the object to be inspected is a perfect circle. However, a tire, strictly speaking, is not a perfect circle, and the distortion can get exaggerated unless the tire is fitted on the rim and inflated with the internal pressure. Hence, it has been difficult for a correction method requiring the assumption of a perfect circle to accurately correct the three-dimensional shape data of an annular rotating body having some distorted contour, such as a tire.

Thus, when the object to be inspected is a tire, the measurements have to be made after limiting the distortion of the tire by fitting the tire on the rim and inflating it with air. This, however, takes time, and it is also necessary to eliminate the eccentricity by matching the central axis of the object to be inspected with the rotational axis thereof when it is rotated.

However, an equipment, such as a high-precision centering mechanism, has to be prepared if an agreement between the central axis and the rotational axis of the object to be inspected is to be achieved.

The present invention has been made in view of the foregoing problems, and an object of the invention is to provide a method for accurately correcting surface shape data of an annular rotating body and an apparatus for inspecting the appearance thereof using the correction method, even when the annular rotating body is far from a perfect circle and besides has an eccentricity.

### Means for Solving the Problem

The present invention provides a method for correcting three-dimensional shape data on a surface of an annular rotating body detected using images of the surface of the annular rotating body which are captured while the annular rotating body and an image capturing means are rotated relatively with each other. The method includes setting a reference line, which is a closed curve along the surface to be detected of the annular rotating body (data area from which three-dimensional shape data are obtained), within a plane perpendicular to a central axis of the annular rotating body,
setting a plurality of reference equiangular division points Pᵢ on the reference line by dividing the reference line by equal angles centered about a rotational center of the relative rotation, calculating a circumferential length I of the reference line, which is a length of a full circle of the reference line, from a distance between adjacent reference equiangular division points Pᵢ and Pᵢ₊₁, setting, on the reference line, a plurality of reference equidistant division points Qⱼ, which divide the reference line into equal lengths, using the circumferential length l, setting interpolation points R_{j,k} for correction of the data on the surface to be detected of the annular rotating body at positions a predetermined distance hₖ apart in a radial direction of the annular rotating body from the reference equidistant division points Qⱼ, calculating three-dimensional shape data at the interpolation points R_{j,k} using the three-dimensional shape data, and moving the interpolation points R_{j,k} onto a perfect circle centered about the rotational center and having the same circumferential length as the circumferential length l, using the circumferential length l and the distance h.

In this manner, the data obtained by measurement at equal angles are converted into data equidistantly divided along a planar shape (reference line) of the surface of an annular rotating body. And this equidistantly divided data are reallocated on a perfect circle without changing the circumferential length of the annular rotating body. Then the shape data on the surface of the annular rotating body can be corrected with accuracy.

The present invention also provides an apparatus for inspecting an appearance (surface shape) of an annular rotating body. The apparatus includes an image acquisition means having a light casting means for casting slit light to a surface to be inspected of the annular rotating body and an image capturing means for imaging a portion illuminated by the slit light, a rotating means for rotating the annular rotating body and the image acquisition means relatively to each other about a rotational axis, an image processing means for calculating three-dimensional data on the surface of the annular rotating body by performing an image processing of the images of the surface of the annular rotating body captured by the image acquisition means, and a data correction means for correcting the three-dimensional data. And the data correction means further includes a reference line setting means for setting a reference line, which is a closed curve along the surface to be inspected of the annular rotating body (data area from which the three-dimensional shape data are obtained) within a plane perpendicular to a central axis of the annular rotating body, an equiangular division point setting means for setting a plurality of reference equiangular division points on the reference line by dividing the reference line by equal angles centered about a rotational center of the relative rotation, a circumferential length calculating means for calculating a circumferential length, which is a full circle length of the reference line, from a distance between adjacent reference equiangular division points, an equidistant division point setting means for setting, on the reference line, a plurality of equidistant division points, which divide the reference line into equal lengths, using the circumferential length, a normal vector calculating means for calculating unit normal vectors at the reference equidistant division points, an interpolation point vector calculating means for calculating interpolation point vectors having a start point at the rotational center from a sum of the division point vector, which has a start point at the rotational center and an end point at the reference equidistant division point, and a direction vector, which has a start point at the reference equidistant division point, faces a direction of the unit normal vector, and is of a magnitude equal to a magnitude of the unit normal vector multiplied by a predetermined distance, an interpolation point data calculating means for calculating depth-direction data of the interpolation points, which are each an end point of the interpolation point vector, using the three-dimensional shape data, and an interpolation point moving means for moving the interpolation points onto a perfect circle centered about the rotational center and having the same circumferential length as the aforementioned circumferential length, using the aforementioned circumferential length and the predetermined distance.

By implementing the configuration as described above, accurate shape data on the surface of the annular rotating body can be obtained. Thus it is possible to perform an appearance inspection of the annular rotating body with accuracy.

It is to be understood that the foregoing summary of the invention does not necessarily recite all the features essential to the invention, and subcombinations of all these features are intended to be included in the invention.

### BRIEF DESCRIPTION OF THE DRAWINGS

FIG. 1 is an illustration showing a configuration of a tire appearance inspection apparatus according to an embodiment of the present invention.

FIG. 2 is an illustration showing an example of point group data on the cross sections of a sidewall region of a tire obtained by a light-section method.

FIG. 3 is an illustration showing how to set a reference line and reference equiangular division points.

FIG. 4 is an illustration showing how to set reference equidistant division points.

FIG. 5 is an illustration showing how to set a unit normal vector.

FIG. 6 is illustrations showing how to set an interpolation point vector and how to calculate depth-direction data on the interpolation point.

FIG. 7 is an illustration showing how to move interpolation points.

FIG. 8 is a flowchart showing the operation of the tire appearance inspection apparatus.

### MODE FOR CARRYING OUT THE INVENTION

Hereinafter, embodiments of the present invention will be described with reference to the drawings.

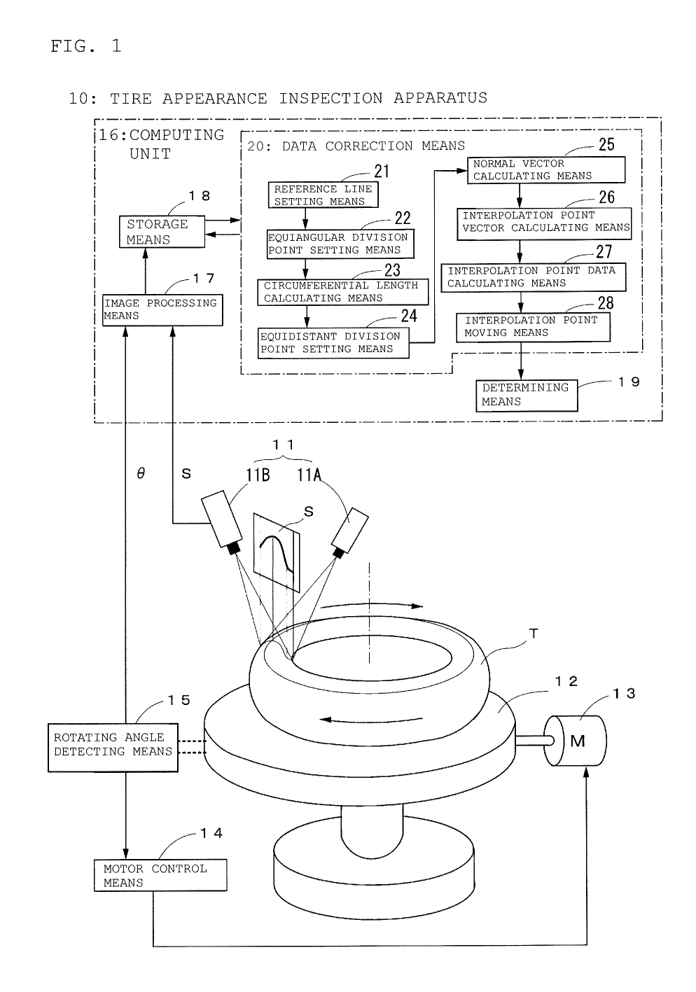

FIG. 1 is an illustration showing a configuration of a tire appearance inspection apparatus 10. As shown in the figure, the tire appearance inspection apparatus 10 includes an image acquisition means 11, a rotating table 12, a drive motor 13, a motor control means 14, a rotating angle detecting means 15, and a computing unit 16.

The respective means from the rotating table 12 through the rotating angle detecting means 15 constitute rotating means for rotating a tire T which is the object to be inspected.

The computing unit 16 includes an image processing means 17, a storage means 18, a determining means 19, and a data correction means 20.

The image acquisition means 11, which comprises a light casting means 11A and an image capturing means 11B, captures images of the surface to be detected of the tire T as the object to be inspected.

The light casting means 11A emits slit light (line light) onto the surface to be detected of the tire T mounted on the rotating table 12. It is, for example, equipped with a monochromatic or white light source, such as a semiconductor laser or halogen lamp.

The image capturing means 11B is equipped with an imaging element disposed planarly and a lens for focusing slit light reflected from the surface of the tire T on the imaging element. It captures an image (slit image S) of the contour of a sidewall surface of the tire T, which is an image of a portion illuminated by the slit light, at every predetermined rotating angle (e.g., 1°) of rotation of the tire T. The image capturing means 11B is an area camera, such as a CCD camera, for instance.

The rotating table 12, which is driven by the drive motor 13, rotates the tire T mounted thereon with the central axis of the tire T as the rotational axis. It is to be noted that as already mentioned, there is not necessarily agreement between the central axis of the tire T and the rotational axis of the rotating table 12 in practice.

The drive motor 13, connected to the rotating table 12, rotates the rotating table 12.

The motor control means 14 controls the drive of the drive motor 13 so that the rotating table 12 rotates at a predetermined rotating speed (e.g., 60 r.p.m.).

The rotating angle detecting means 15 detects the rotating angle of the tire T (in fact, the rotating angle of the rotating table 12). The rotating angle detecting means 15 is a rotary encoder, for instance.

It is to be noted that a stepping motor may be used as the drive motor 13 to turn the rotating table 12 in increments of a predetermined angle. In such a case, the rotating angle detecting means 15 may be omitted.

The computing unit 16 is a computer consisting of not-shown hardware, such as a CPU, ROM, RAM, and the like. The CPU, by performing arithmetic processing according to the program stored in the ROM, functions as the image processing means 17, the determining means 19, and the data correction means 20. Note that the storage means 18 is configured by a RAM, which is a rewritable memory.

The image processing means 17 calculates three-dimensional shape data on a sidewall surface by performing an image processing of the image (slit image S) of the contour of the sidewall surface of the tire T captured by the image acquisition means 11. More specifically, coordinates of gravity center of pixels lit up out of a plurality of pixels constituting the slit image are calculated to determine two-dimensional coordinates (x_{i,k}, z_{i,k}) of positions (measuring points P_{i,k}) of the slit image S. And three-dimensional coordinate data of the measuring points P_{i,k} are determined from the two-dimensional coordinates (x_{i,k}, z_{i,k}) and a rotating angle θᵢ of the tire T detected by the rotating angle detecting means 15.

It is to be noted that the index i denotes a circumferential position of the measuring point P_{i,k} (measuring point at rotating angle θᵢ) and the index k denotes a radial position (kth measuring point from the rotational center O).

By repeating the operation as described above for every slit image (at every rotating angle Δθ), the three-dimensional shape data on the sidewall surface for a full circle of the tire, which consist of the point group data P_{i,k} of cross sections at equal angles passing through the rotational center O, can be calculated. The above-mentioned rotating angle Δθ can be expressed as Δθ=2 π/n.

Here, if θᵢ=i·Δθ (i=1 to n) and the number of measuring points P_{i,k} in the θᵢ direction is denoted by mᵢ, then the total of the measuring points P_{i,k} can be written as N=(m₁+m₂+m+ . . . +mᵢ+ . . . mₙ). It is to be noted that the three-dimensional shape data on the sidewall surface can normally be expressed in the form of cylindrical coordinates, namely, P_{i,k}=(r_{i,k}, θᵢ, z_{i,k}).

The storage means 18 stores three-dimensional shape data on the sidewall surface of a standard tire (non-defective tire) which serve as the reference for acceptance or rejection of the appearance of the tire T, three-dimensional coordinate data of measuring points P_{i,k}, which are the three-dimensional shape data on the sidewall surface calculated by the image processing means 17, and other data, such as the reference line K, reference equiangular division points Pᵢ, and reference equidistant division points Qᵢ, set or calculated by the data correction means 20 to be discussed later.

The determining means 19 determines the acceptance or rejection of the tire T by comparing the three-dimensional shape data on the sidewall surface corrected by the data correction means 20 against the three-dimensional shape data on the sidewall surface of the standard tire having been stored in advance in the storage means 18.

The data correction means 20 includes a reference line setting means 21, an equiangular division point setting means 22, a circumferential length calculating means 23, an equidistant division point setting means 24, a normal vector calculating means 25, an interpolation point vector calculating means 26, an interpolation point data calculating means 27, and an interpolation point moving means 28.

The normal vector calculating means 25 and the interpolation point vector calculating means 26 correspond to the means for realizing the step of setting interpolation points in claim 1.

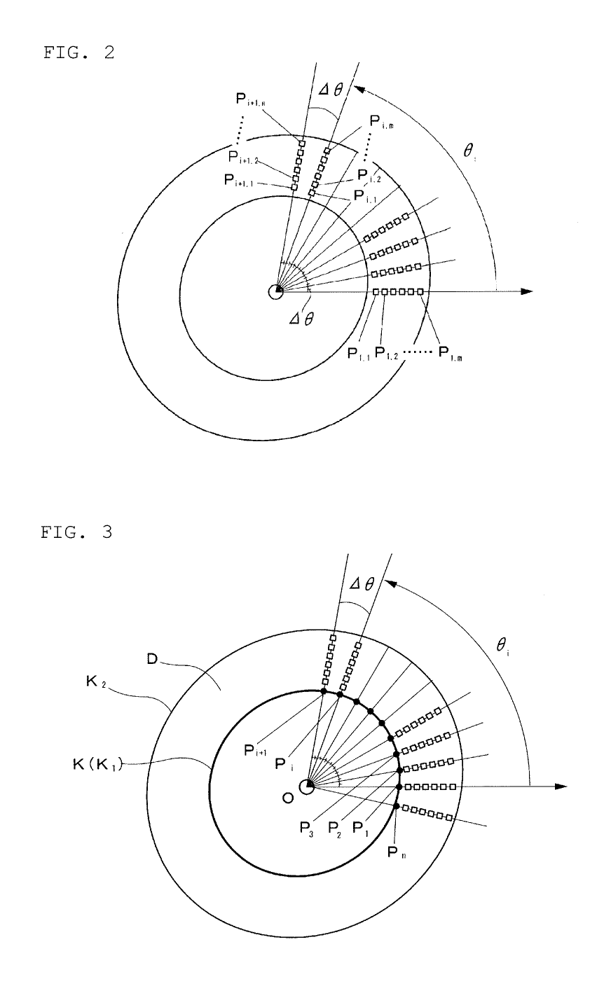

As shown in FIG. 3, the reference line setting means 21 sets a reference line K, which is a closed curve along the shape of data area D, and the equiangular division point setting means 22 sets a plurality of reference equiangular division points Pᵢ (i=1 to n) on the reference line K.

It is to be noted that the data area D refers to the area consisting of point group data on the equiangular cross sections passing through the rotational center O. That is, the data area D, which is the area enclosed by the rim line K₁ and the shoulder line K₂, is the area where three-dimensional coordinate data are calculated by the image processing means 17. Also, the closed curve along the shape of data area D refers to a closed curve similar to the rim line K₁ or the shoulder line K₂.

In the present example, the reference line K is represented by the rim line K₁, which is the inner circumference of the data area D.

The reference equiangular division points Pᵢ (i=1 to n) are the points set on the reference line K which divide it by n equal angles centered about the rotational center O. As is clear from how the reference equiangular division points Pᵢ are set, there are m_{i,j} points of measuring points P_{i,1} to P_{i, mij}, which constitute the data area D, on the extension of the lines connecting the rotational center O with the reference equiangular division points Pᵢ (see FIG. 2).

The circumferential length calculating means 23 calculates the total length of the reference line (hereinafter referred to as circumferential length l), which is the full circle length of the reference line K, from the distance ΔPᵢ between the adjacent reference equiangular division points Pᵢ and Pᵢ₊₁. That is, the circumferential length l=ΔP₁+ΔP₂+ . . . +ΔPₙ (where ΔPₙ is the distance between Pₙ and P₁).

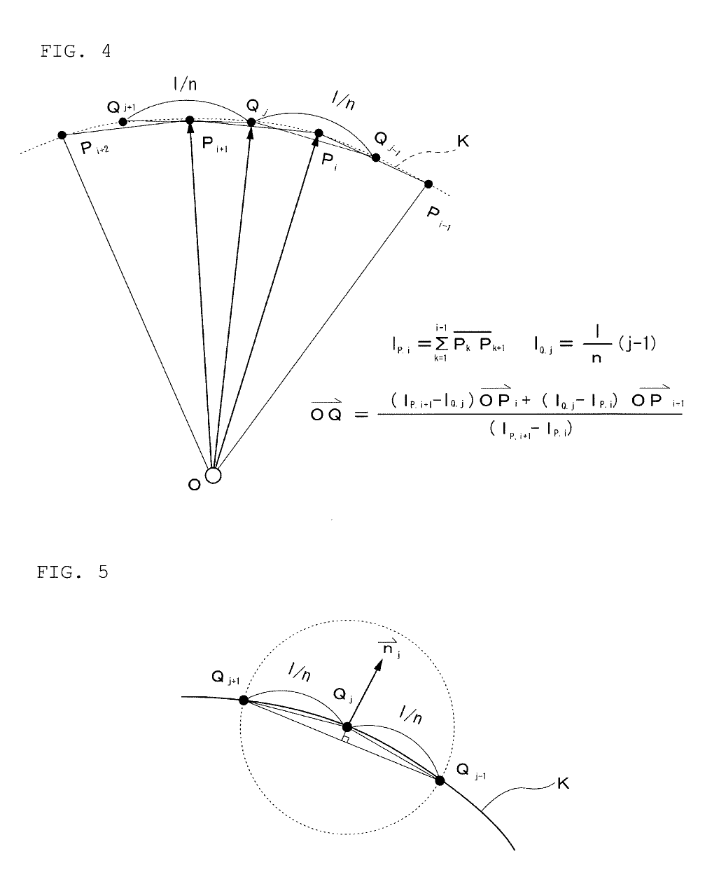

The equidistant division point setting means 24, as shown in FIG. 4, sets a plurality of reference equidistant division point Qⱼ (j=1 to n), which divide the reference line K into equal lengths, on the reference line K, using the circumferential length l.

More specifically, the positions of the reference equidistant division points Qⱼ are calculated from the length l_{P,i} of the polygonal lines P₁ P₂ . . . Pᵢ and the length l_{Q,j} of the polygonal lines Q₁ Q₂ . . . Qⱼ. Since the length of the segment Qₖ Qₖ₊₁ is l/n, the length of the polygonal lines Q₁ Q₂ . . . Qⱼ is l_{Q,j}=(j−1)·(l/n). Hence, the positions of the reference equidistant division points Qⱼ can be calculated as the points which internally divide the two reference equiangular division points Pᵢ and Pᵢ₊₁ adjacent to Qⱼ at (l_{Q,j}−l_{P,i}):(l_{P,i+1}−l_{Q,j}). Normally, since the distance ΔPᵢ between the reference equiangular division points Pᵢ and Pᵢ₊₁ is much shorter than the length of the reference line K, the reference equidistant division points Qⱼ can be assumed to be the points on the reference line K.

The normal vector calculating means 25, as shown in FIG. 5, calculates the unit normal vector nⱼ at the reference equidistant division point Qⱼ. In this example, the unit normal vector nⱼ is the unit vector passing through the reference equidistant division point Qⱼ and perpendicular to the segment connecting the two reference equidistant division points Qⱼ₋₁ and Qⱼ₊₁ adjacent to the reference equidistant division point Qⱼ.

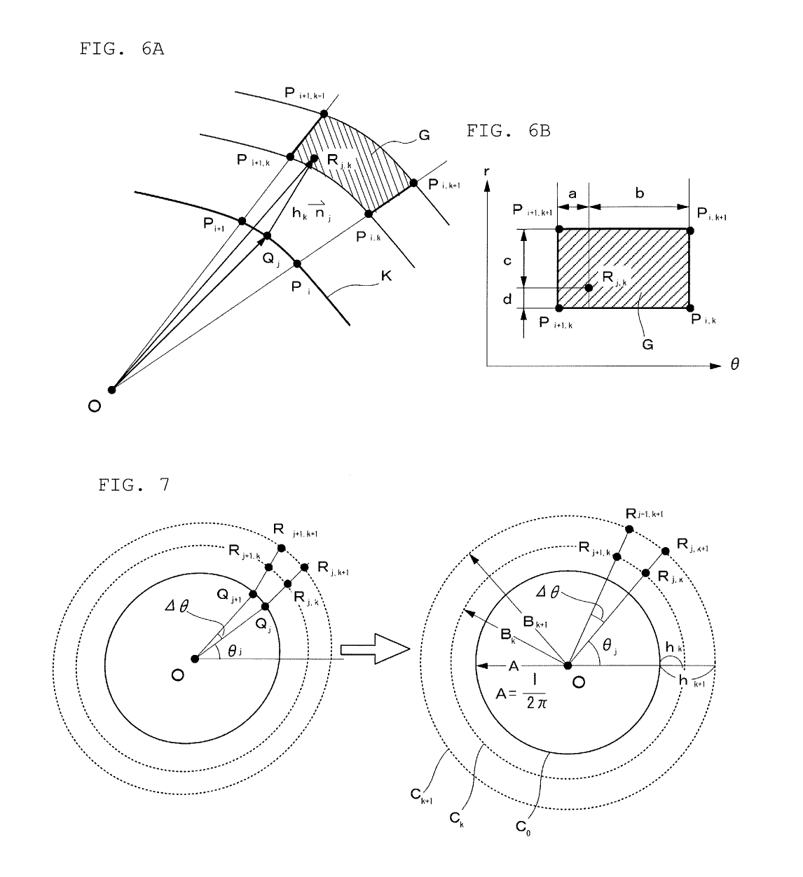

The interpolation point vector calculating means 26, as shown in FIG. 6A, calculates the interpolation point vector OR_{j,k} having the start point at the rotational center from the sum (vector sum) of the division point vector OQᵢ, which has the start point at the rotational center O and the end point at the reference equidistant division point Qⱼ, and the direction vector QⱼR_{j,k}, which has the start point at the reference equidistant division point Qⱼ, faces the direction of the unit normal vector and is of a magnitude equal to the magnitude of the unit normal vector multiplied by the preset distance hₖ.

The distance hₖ is of a value independent of the rotating angle θᵢ. In order to make a maximum use of the three-dimensional data, it may, for example, be hₖ=Δpₘᵢₙ·k using the minimum value Δpₘᵢₙ of the interval between measuring points P_{i,k} in the radial direction. Or it may be hₖ=Δrₘᵢₙ·k using the resolution Δrₘᵢₙ in the tire radial direction necessary to achieve accuracy in the acceptance or rejection of the tire.

As already mentioned, there are mᵢ points of measuring points P_{i,1} to P_{i, mij} on the extension of the lines connecting the rotational center O with the reference equiangular division points Pᵢ. Therefore, by setting i,k as appropriate, an area G defined by the measuring points P_{i,k}, P_{i,k+1}, P_{i+1,k}, P_{i+1,k+1} surrounding the interpolation point R_{j,k}, which is the end point of the interpolation vector OR_{j,k}, can be set.

The interpolation point data calculating means 27, as shown in FIG. 6B, calculates the depth-direction data Z_{i,k} of the interpolation point R_{j,k} using the depth-direction data Z_{i,k}, z_{i,k+1}, z_{i+1,k}, z_{i+1,k+1} of the measuring points P_{i,k}, P_{i,k+1}, P_{i+1,k}, P_{i+1,k+1} calculated by the image processing means 17.

More specifically, the area G enclosed by the arc passing through the measuring points P_{i,k} and P_{i+1,k}, the arc passing through the measuring points P_{i,k+1} and P_{i+1,k+1}, the straight line passing through the measuring points P_{i,k} and P_{i,k+1}, and the straight line passing through the measuring points P_{i+1,k} and P_{i+1,k+1} is assumed to be a rectangle having the vertical sides (r) equal to the distance between P_{i,k} and P_{i,k+1} and the horizontal sides (θ) equal to the distance between P_{i,k} and P_{i+1,k} by use of the r−θ coordinate system (polar coordinates). And the depth-direction data Z_{j,k} of the interpolation point R_{j,k} is calculated by a bilinear interpolation. That is, Z_{j,k} is calculated using the following equation on the assumption that in the r−θ coordinate system (polar coordinates), the θ coordinates of R_{j,k} are equal to the θ coordinates that internally divide the distance between P_{i,k} and P_{i+1,k} at a:b (a+b=1) and the r coordinates are equal to the r coordinates that internally divide the distance between P_{i,k} and P_{i,k+1} at c:d (c+d=1).

### Equation 1

Z_{j,k}=b·c·z_{i,k}+a·c·z_{i+1,k}+b·d·z_{i,k+1}+a·d·z_{i+1,k+1}

It should be noted that the depth-direction data Z_{j,k} of the interpolation point R_{j,k} may be calculated using another interpolation method, such as bicubic method, in the place of the bilinear method. Thus, setting the interpolation point R_{j,k} using the procedure as described above will achieve an accurate interpolation of the three-dimensional shape data of the data area. And this will improve the interpolation accuracy of the shape data on the surface of an annular rotating body.

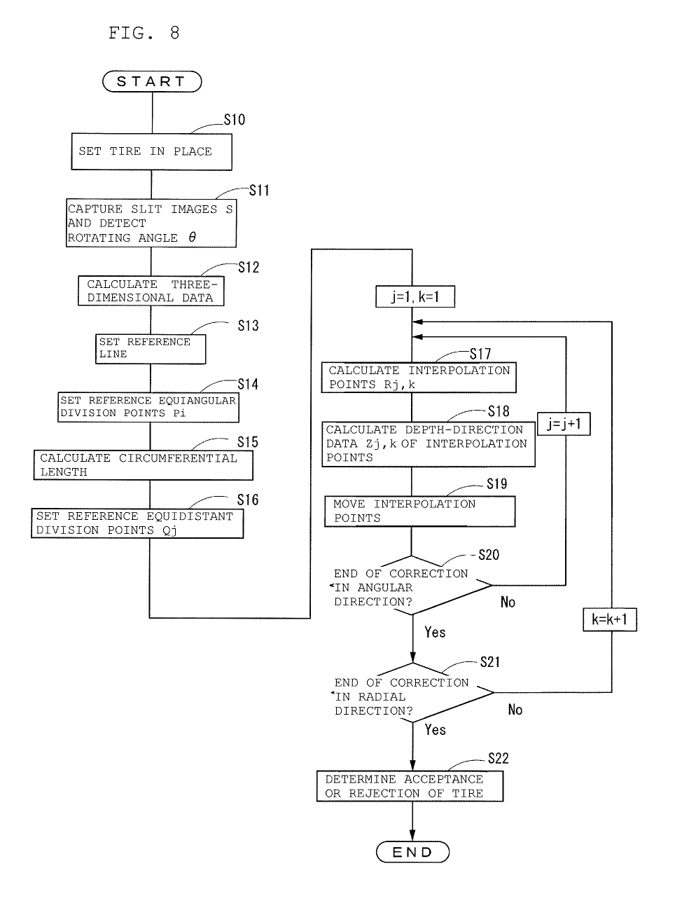

The interpolation point moving means 28, as shown in FIG. 7, allocates the interpolation points R_{j,k} on a circle Cₖ, which is concentric with the circle C₀ centered about the rotational center O and having the circumferential length l.

The radius of the circle C₀ having the circumferential length l is A=½ π. Also, the interpolation points R_{j,k} are the points displaced radially outward by hₖ from the reference equidistant division points Qⱼ. Hence, expressed in cylindrical coordinates, the coordinates of the interpolation point R_{j,k} are R_{j,k}=(Bₖ, θⱼ, Z_{j,k}). Here Bₖ, the radius of the circle Cₖ to which the interpolation point R_{j,k} has been moved, is Bₖ=A+hₖ. Also, θⱼ, which is the rotating angle of the interpolation point R_{j,k} about the rotational center O, is θⱼ=j·(2π/n) where j=1 to n.

Now, a description is given of the operation of a tire appearance inspection apparatus according to the present invention with reference to the flowchart of FIG. 8.

First the tire T is set in place (step S10). More specifically, the tire T is mounted on the rotating table 12 and rotated to the initial position (θᵢ=0 rad) with the drive motor 13 driving the rotating table 12.

Next, while the tire T is rotated, the images (slit images S) of the sidewall surface of the tire T are captured by the image acquisition means 11. At the same time, the rotating angle θ of the tire T is detected by the rotating angle detecting means 15 (step S11). Then the three-dimensional shape data on the sidewall surface are calculated by the image processing means 17 from the captured slit images S and the rotating angle θ of the tire T (step S12).

Next, the calculated three-dimensional shape data are corrected using the data correction means 20.

More specifically, as shown in FIG. 3, the reference line K along the shape of the data area ID is set using the reference line setting means 21 (step S13). Then the reference equiangular division points Pᵢ (i=1 to n) are set on the reference line K by the equiangular division point setting means 22 (step S14). The reference equiangular division points Pᵢ are the points that divide the reference line K into n divisions of equal angles about the rotational center O.

Next, the circumferential length l of the reference line K is calculated by the circumferential length calculating means 23, using the distance ΔPi between the reference equiangular division points Pᵢ and P₁₊₁ (step S15). Then the reference equidistant division points Qⱼ (j=1 to n) are set on the reference line K, using the calculated circumferential length l (step S16). The reference equidistant division points Qⱼ (j=1 to n) are the points that divide the reference line K into equal lengths.

Next, the interpolation point R_{j,k} for correction of the three-dimensional data is calculated by the normal vector calculating means 25 and the interpolation point vector calculating means 26, using the previously set reference equidistant division point Qⱼ (step S17).

The interpolation points R_{j,k} are each the point within the data area D which is obtained by moving the reference equidistant division point Qⱼ by the distance hₖ in the tire radial direction. More specifically, the interpolation points R_{j,k} are each the position at the end point of the interpolation point vector OR_{j,k}, which can be derived as the vector sum of the division point vector OR_{j,k} that has the start point at the rotational center O and the end point at the reference equidistant division point Qⱼ and the direction vector QⱼR_{j,k} that has the start point at the reference equidistant division point Qⱼ, faces the direction of the unit normal vector nⱼ, and is of a magnitude equal to the distance hₖ.

Next, the depth-direction data Z_{j,k} of the interpolation point R_{j,k} are calculated by the interpolation point data calculating means 27 from the depth-direction data of the measuring points P_{i,k}, P_{i,k+1}, P_{i+1,k}, P_{i+1,k+1} surrounding the interpolation point R_{j,k} (step S18).

Next, the interpolation points R_{j,k} are moved onto a circle concentric with the circle C₀ centered about the rotational center O and having the circumferential length l by the interpolation point moving means 28 (step S19).

As is indicated in step S20 and step S21, all the interpolation points R_{j,k} can be allocated on the circle Cₖ centered about the rotational center O by repeating the operations of step S17 and step S18 in the angular direction and the radial direction, respectively.

Finally, the acceptance or rejection of the tire T is determined by comparing the corrected three-dimensional shape data on the sidewall surface against the three-dimensional shape data on the sidewall surface of the standard tire (step S22).

In the foregoing specification, the invention has been described with reference to specific embodiments thereof. However, the technical scope of this invention should not be considered as limited to those embodiments. It will be evident to those skilled in the art that various modifications and changes may be made thereto without departing from the broader spirit and scope of the invention. It will also be evident from the scope of the appended claims that all such modifications are intended to be included within the technical scope of this invention.

For example, in the foregoing embodiments, the rim line, which is the inner circumference of the data area D, is employed as the reference line K. However, the shoulder line, which is the outer circumference of the data area D, may be employed as the reference line K. In such a case, it goes without saying that the unit normal vector nⱼ must face radially inward of the tire.

Also, in the foregoing embodiments, the number n′ of the reference equidistant division points Q is the same as the number n of the reference equiangular division points P. However, it may be n′<n or conversely n′>n. In this case, the reference equidistant division point Qⱼ is not the internally dividing point of the adjacent reference equiangular division points Pᵢ and Pᵢ₊₁. But the coordinates of the reference equidistant division point Qⱼ can be calculated using the length l_{P, i} of the polygonal lines P₁ P₂ . . . Pᵢ and the length l_{q,j} of the polygonal lines Q₁ Q₂ . . . Qⱼ, namely, l_{q,j}=(j−1)·(l/n′), in the same way as in the foregoing embodiments. Also, the number mⱼ′ of the interpolation points R_{j,k} at the rotating angle θᵢ may be smaller than mⱼ. However, if the three-dimensional shape data detected by the light-section method are to be put to an effective use, it is preferable that n′≧n and mⱼ′≧mⱼ as in the present embodiment.

Also, the foregoing embodiments have been described in regard to the method for correcting the three-dimensional shape data on a sidewall region of a tire derived by a light-section method. However, the surface shape data may be that of a part of the annular rotating body, such as a part of the sidewall region. The distortion of a tire itself conceivable from the materials and structure thereof is limited; there is no such distortion as may “change the circumferential length”. Therefore, the surface shape data on the sidewall region (or the surface shape data on the tread region) of the tire measured at equal angles by applying the above-described method to the tire may be converted into the data divided equidistantly. And the equidistantly divided data may be reallocated on a perfect circle in such a manner that there is no change in circumferential length. Then the shape data on the surface of the tire can be corrected with excellent accuracy.

Moreover, the surface shape data on the sidewall region or the tread region of a tire can be detected accurately without fitting the tire on the rim and filling air into it. In this manner, the measuring time can be shortened markedly.

Also, there is no need to use a high-precision centering mechanism, which will simplify the equipment. Moreover, the data to be used may be the surface shape data on the tread region. Further, the surface shape data may be that obtained by methods such as stereo camera or moire topography, other than the light-section method. Also, now that the annular rotating body is a tire, a tire appearance inspection apparatus capable of measuring tire surface shape data at high speed and low cost can be provided.

Furthermore, the foregoing embodiments are based on the assumption that the annular rotating body, which is the object to be inspected, is a tire. However, the invention is not limited thereto. It is applicable to the inspection of members constituting part of an annular rotating body such as silicon resin lids of pots, circular products such as pots themselves, and surfaces (sides) of semicylindrical resin products.

### DESCRIPTION OF REFERENCE NUMERALS

10 tire appearance inspection apparatus

11 image acquisition means

11A light casting means

11B image capturing means

12 rotating table

13 drive motor

14 motor control means

15 rotating angle detecting means

16 computing unit

17 image processing means

18 storage means

19 determining means

20 data correction means

21 reference line setting means

22 equiangular division point setting means

23 circumferential length calculating means

24 equidistant division point setting means

25 normal vector calculating means

26 interpolation point vector calculating means

27 interpolation point data calculating means

∞interpolation point moving means

T tire

1. A method for correcting three-dimensional shape data on a surface of an annular rotating body detected using images of the surface of the annular rotating body which are captured while the annular rotating body and an image capturing means are rotated relatively with each other, the method comprising:
setting a reference line, which is a closed curve along the surface to be detected of the annular rotating body, within a plane perpendicular to a central axis of the annular rotating body;
setting a plurality of reference equiangular division points on the reference line by dividing the reference line by equal angles centered about a rotational center of the rotation;
calculating a circumferential length of the reference line, which is a length of a full circle of the reference line, from a distance between adjacent reference equiangular division points;
setting, on the reference line, a plurality of reference equidistant division points, which divide the reference line into equal lengths, using the circumferential length;
setting interpolation points for correction of data on the surface to be detected of the annular rotating body at positions a preset distance apart in a radial direction of the annular rotating body from the reference equidistant division points;
calculating three-dimensional shape data at the interpolation points, using the three-dimensional shape data; and
moving the interpolation points onto a perfect circle centered about the rotational center and having a circumferential length same to the circumferential length of the reference line, using the circumferential length of the reference line and the preset distance.

2. The method for correcting surface shape data of an annular rotating body according to claim 1, wherein
in the setting interpolation points, unit normal vectors at the reference equidistant division points are calculated, then a vector sum of a division point vector, which has a start point at the rotational center and an end point at the reference equidistant division point, and a direction vector, which has a start point at the reference equidistant division point, faces a direction of the unit normal vector, and is of a magnitude equal to a magnitude of the unit normal vector multiplied by the predetermined distance, is obtained as each of interpolation point vectors, and an end point of the interpolation point vector when a start point of the interpolation point vector is the rotational center is used as each of the interpolation points, and
in the calculating three-dimensional shape data at the interpolation points, depth-direction data of the interpolation points are calculated using the three-dimensional shape data.

3. The method for correcting surface shape data of an annular rotating body according to claim 1, wherein the annular rotating body comprises a tire, and the three-dimensional shape data comprise surface shape data on a sidewall region or a tread region of the tire determined by a light-section method.

4. An apparatus for inspecting an appearance of an annular rotating body comprising:
an image acquisition means having a light casting means for casting slit light to a surface to be inspected of the annular rotating body and an image capturing means for imaging a portion illuminated by the slit light;
a rotating means for rotating the annular rotating body and the image acquisition means relatively to each other about a rotation axis;
an image processing means for calculating three-dimensional data on the surface of the annular rotating body by performing an image processing of the images of the surface of the annular rotating body captured by the image acquisition means; and
a data correction means for correcting the three-dimensional data,
wherein the data correction means further comprises:
a reference line setting means for setting a reference line, which is a closed curve along the surface to be detected of the annular rotating body, within a plane perpendicular to a central axis of the annular rotating body,
an equiangular division point setting means for setting a plurality of reference equiangular division points on the reference line by dividing the reference line by equal angles centered about a rotational center of the relative rotation,
a circumferential length calculating means for calculating a circumferential length, which is a full circle length of the reference line, from a distance between adjacent reference equiangular division points,
an equidistant division point setting means for setting, on the reference line, a plurality of equidistant division points, which divide the reference line into equal lengths, using the circumferential length,
a normal vector calculating means for calculating unit normal vectors at the reference equidistant division points,
an interpolation point vector calculating means for calculating interpolation point vectors having a start point at the rotational center from a sum of the division point vector, which has a start point at the rotational center and an end point at the reference equidistant division point, and a direction vector, which has a start point at the reference equidistant division point, faces a direction of the unit normal vector, and is of a magnitude equal to a magnitude of the unit normal vector multiplied by a predetermined distance,
an interpolation point data calculating means for calculating depth-direction data of the interpolation points, which are each an end point of the interpolation point vector, using the three-dimensional shape data, and
an interpolation point moving means for moving the interpolation points onto a perfect circle centered about the rotational center and having the same circumferential length as the circumferential length, using the circumferential length and the predetermined distance.

5. The apparatus for inspecting an appearance of an annular rotating body according to claim 4, wherein the annular rotating body comprises a tire.

6. The method for correcting surface shape data of an annular rotating body according to claim 2, wherein the annular rotating body comprises a tire, and the three-dimensional shape data comprise surface shape data on a sidewall region or a tread region of the tire determined by a light-section method.
